(19) United States
(12) Patent Application Publication
(10) Pub. No.: US 2018/0049003 A1
(43) Pub. Date: Feb. 15, 2018

(54) PASSIVE AND ACTIVE LOCATION TRACKING FOR MOBILE DEVICES

(71) Applicants: Reid Jonathon Maulsby, Atlanta, GA (US); Nathan Thomas Halsey, Atlanta, GA (US)

(72) Inventors: Reid Jonathon Maulsby, Atlanta, GA (US); Nathan Thomas Halsey, Atlanta, GA (US)

(21) Appl. No.: 15/674,706

(22) Filed: Aug. 11, 2017

Related U.S. Application Data
(60) Provisional application No. 62/373,467, filed on Aug. 11, 2016.

(51) Int. Cl. H04W 4/02

(52) U.S. Cl. CPC H04W 4/028

(57) ABSTRACT

An apparatus, system, and method for tracking users by using a background-embedded observer are described. The observer is embedded within one or more application residing on a device, such as a smartphone. The embedded observer receives information from various sensors on the device, including wireless radios. By sensing the identifiers of the wireless radios, the embedded observer can improve geolocation accuracy where GPS signals are often too weak, such as indoors. The wireless radio identifier information can be correlated with the information produced by other users to improve accuracy.

### CROSS-REFERENCE TO RELATED APPLICATIONS

This application claims priority from U.S. Provisional Patent Application No. 62/373,467, filed on Aug. 11, 2016, which is relied upon and incorporated herein in its entirety by reference.

### BACKGROUND OF THE INVENTION

### Technical Field

The present invention is in the technical fields of geo-location and data analytics. More precisely, the present invention relates to improved location accuracy by combining the inputs of multiple sensors and wireless beacons to produce fused data sets about the location and activities of persons.

### Related Art

Mobile devices often include various subsystems and functions to connect wirelessly to various types of transmitters. Most of these wireless connectivity systems are present so that the device can communicate through one or more communications networks. The device may wirelessly connect to a cellular network through one or more cell towers or to a wireless local area network through one or more wireless access points to support these connections. The mobile device may include cellular subsystems and functions that permit voice communication between the mobile device and other cellular devices. Additionally, the mobile device can include data communication subsystems and functions that permit the mobile device to transmit and receive data through a data network, such as the Internet. As part of these wireless subsystems, data related to the nature of the present wireless communication networks is generated by broadcasts or during connection, establishment, and communication, which can be made available to applications residing on the mobile device.

One common subsystem, the Global Positioning System (GPS), has the ability to find and track location of mobile devices, enabling new applications including Location Based Services (LBS). GPS can directly provide location data. However, GPS is limited in its resolution and typically requires a clear view of the sky to receive the satellite signals. Further, GPS often cannot detect when a mobile device is indoors, accurately track objects indoors, or determine if a mobile device is in a vehicle or other conveyance.

Cellular service providers can also provide location information to mobile devices through the cellular network. For example, the cellular network may compare signal strength at various base stations to determine the approximate location using triangulation. However, current implementations of this technology suffer from inaccuracies arising from various sources of signal fading, such as the presence of buildings or walls. Regardless, it is desirable to detect or track mobile devices indoors for applications such as safety, e-business, gaming, directions, or the like.

Specifically designed indoor transponders using new protocols can assist in locating mobile devices indoors. However, these indoor transponders require the installation of special purpose base stations and require additional hardware in the mobile device. It is desirable to locate a mobile device indoors without the need for specially tailored hardware. Further, while there are other types of transmitters used where cellular and GPS provide poor location estimates, these transmitters are not designed specifically for geo-location applications. For example, Wi-Fi access points and other devices are commonly present indoors where the GPS signal may be too weak to produce a location estimate. Other transmitters are also becoming prevalent, such as Near Field Communication (NFC) or Bluetooth transmitters. These transmitters commonly operate on lower power levels than cellular or Wi-Fi transmitters, but users typically interact with them in closer proximity.

Therefore, there is a need for a system for accurately geo-locating a mobile device when in the presence of common communication network transmitters, such as Wi-Fi, Bluetooth, and NFC.

### SUMMARY OF INVENTION

The present invention relates to using mobile device communication radios. Mobile devices can connect via a variety of wireless communications networks via a variety of wireless radios. For example, a device can wirelessly connect to a cellular network through one or more cell towers or to a wireless local area network through one or more wireless access points. The present invention, in an embodiment, can connect to these various networks.

The present invention further relates to wireless communication network payload and interface data. This data, including information of a device ID, a wireless radio ID, or a base station ID, or various other universally unique identifiers (UUID) can be gathered, when the mobile device is within range of a communication network, and processed in real time or logged for later analysis. This data is useful to a manufacturer of the mobile device for improving design of the mobile device, the operator of the communications network for modifying topology of the network, or to advertisers for generating targeted content.

The present invention further relates to data analytics. The data received by the system is applicable to learning information about users. The system can gain insight into where users travel. This information may help to understand which products and locations in a store are most popular, where employees are present at any given time, and which marketing displays are most effective. The data can also be used to improve emergency evacuation plans.

The present invention, according to an aspect, provides a background wireless monitoring capability via an application residing on a mobile device. In such aspects, the application is modifiable to include logging functionality through a software development kit (SDK). The operation of the background wireless monitoring capability can be hidden from the user interface of the application.

This summary does not limit the scope of the claimed subject matter. Furthermore, the claimed subject matter is not constrained to the limitations that solve any or all disadvantages noted in any part of this disclosure. Features, aspects and advantages of the present invention are understood with reference to the following description, appended claims and accompanying figures.

### BRIEF DESCRIPTION OF THE DRAWINGS

FIG. 1 is a diagram of a mobile device used in detecting, locating, positioning, or tracking, according to an aspect of the present invention.

FIG. 2 is a schematic diagram of a tracking system with server components, according to an aspect of the present invention.

FIG. 3 is a flow diagram of the data capture and analysis process for Bluetooth beacons, according to an aspect of the present invention.

FIG. 4 is a flow diagram of a process performed by the mobile observer system operation, according to an aspect of the present invention.

FIG. 5 is a flow diagram of steps to process collected data into according to an aspect of the present invention.

### DETAILED DESCRIPTION OF THE EMBODIMENTS

In the following detailed description of the preferred embodiments, reference is made to the accompanying drawings, which form a part hereof, and within which are shown by way of illustration specific embodiments by which the invention may be practiced. It is understood that other embodiments may be utilized and structural changes may be made without departing from the scope of the invention.

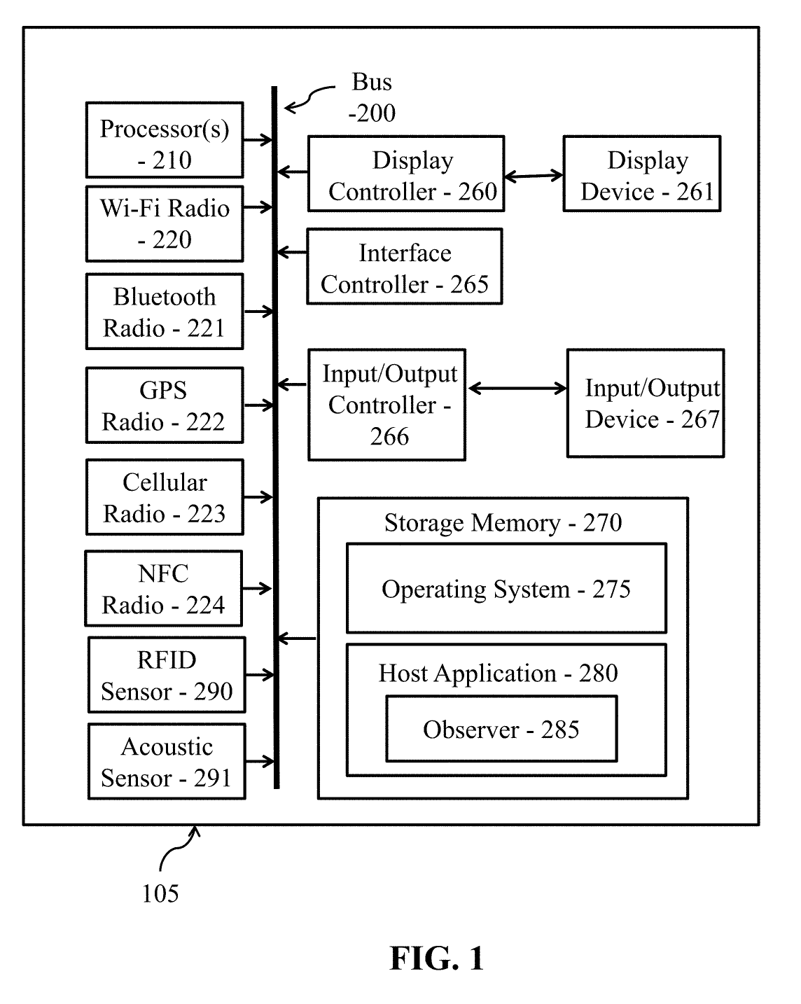

FIG. 1 is a diagram of a mobile device 105 utilized by a system according to an aspect of the present invention. As shown, the mobile device 105 is configured for detecting, locating, positioning, or tracking indoors, or in a conveyance, the location of the mobile device 105. The mobile device 105 comprises a computer bus 200 coupled to at least one or more processors 210, one or more interface controllers 265, storage memory 270 containing an operating system 275 and a host application 280, a power source (not shown), and/or one or more display controllers 260. The power source for mobile device 105 may be a plug-in, battery, fuel cells, solar panels for receiving and storing solar energy, or a device for receiving and storing wireless power.

The processor(s) 210 may be a general-purpose processor, a special-purpose processor, a conventional processor, a digital signal processor, a plurality of microprocessors, a controller, a microcontroller, single core processor, a multi-core processor, an Application Specific Integrated Circuit, a Field Programmable Gate Array circuit, or any other type of integrated circuit. In some aspects, the processor 210 can comprise multiple processors 210. The display controller 260 connects to one or more display devices 261. The one or more display devices 261 may include a liquid crystal display, light emitting diode display, field emission display, organic light-emitting diode display, flexible organic light emitting diode display, or the like. Coupled to the computer bus 200 are one or more input/output controller 266 and/or I/O devices 267. Examples of input/output devices 267 include, but are not limited to, a speaker, microphone, keyboard, keypad, touchpad, display, touchscreen, wireless gesture device, a digital camera, a digital video recorder, a force-feedback device, or the like.

The mobile device 105 can include a plurality of sensors 290, 291. As shown in FIG. 1, the sensors can include a radio frequency identification (RFID) sensor 290 and an acoustic sensor 291. However, the plurality of sensors is not limited to RFID and acoustic sensors 290, 291, nor only two sensors. The plurality of sensors can include, but are not limited to, one or more motion, proximity, light, optical, chemical, environmental, moisture, acoustic, heat, temperature, RFID, biometric, face recognition, image, photo, or voice recognition sensors and touch detectors (not shown) for detecting any touch inputs, including multi-touch inputs, for one or more display devices. Sensors can further include, but are not limited to, an accelerometer, an e-compass, gyroscope, a 3D gyroscope, or the like. One or more interface controllers 265 may communicate with touch detectors and input/output controller 266 for determining user inputs to the mobile device 105. Coupled to one or more display devices 267 may be pressure or capacitive sensors for detecting presses on one or more display devices 267.

Still referring to the mobile device 105, the storage memory 270 may be any disk based or solid-state memory device for storing data. The storage memory 270 may comprise volatile or non-volatile memory. The storage memory 270 can contain the host application 280, which, in an aspect, contains an observer 285, discussed in more detail below.

The mobile device 105 can include cellular radio(s) 223. In an aspect, the cellular radio(s) 223 can include, but are not limited to, a Frequency Division Multiple Access (FDMA), single carrier FDMA (SC-FDMA), Time Division Multiple Access (TDMA), Code Division Multiple Access (CDMA), Orthogonal Frequency-Division Multiplexing (OFDM), Orthogonal Frequency-Division Multiple Access (OFDMA), Global System for Mobile (GSM) communications, Interim Standard 95 (IS-95), IS-856, Enhanced Data rates for GSM Evolution (EDGE), General Packet Radio Service (GPRS), Universal Mobile Telecommunications System (UMTS), cdma2000, wideband CDMA (W-CDMA), High-Speed Downlink Packet Access (HSDPA), High-Speed Uplink Packet Access (HSUPA), High-Speed Packet Access (HSPA), Evolved HSPA (HSPA+), long term evolution (LTE), LTE Advanced (LTE-A), 802.11x, Wi-Fi, Zigbee, Ultra-WideBand (UWB), 802.16x, 802.15, Wi-Max, and mobile Wi-Max via one or more antennas.

Likewise, the mobile device 105 can include a Bluetooth Radio 221, a Wi-Fi Radio 220, GPS Radio(s) 222, and NFC Radio(s) 224. In an aspect, the Bluetooth radio 221 connects to the computer bus 200 and communicates using the Bluetooth standard. A Wi-Fi radio 220 connects to the computer bus 200 and can communicate using any of the 802.11 standards, including, but not limited to, 802.11ac, 802.11n, 802.11g, 802.11a, and 802.11b. In an aspect, one or more Global Positioning System radio(s) 222 and one or more NFC radio(s) 224 can be coupled to the computer bus 200. In an aspect, the wireless radios, including, but not limited to, the Wi-Fi radio 220, the Bluetooth radio 221, the GPS radio 222, the cellular radio 223, and the NFC radio 224, are each configured to act as sensors for the observer 285.

The observer 285, via the wireless radios 221, 222, 223, 224, is able to gather information, passively or actively, from appropriate transmitters in the vicinity of the mobile device 105. In an aspect, the host application 280 contains the observer 285. The observer 285 comprises executable code that includes the logic for collecting and transmitting the tracking data from the appropriate transmitters through the wireless radios 221, 222, 223, 224 via callbacks. In an aspect, the observer 285 is embedded in the host application 280 via a software development kit (SDK)(not shown). In aspect, the observer 285, developed with the SDK, is a software application operating within another software application (i.e., the host application 280). Application developers using the observer SDK are able to generate code for the observer 285 that will execute as part of the host application 280. The observer SDK uses callbacks that are instantiated separately from the main code of the host application 280, thereby preventing interference with the main functionality of the host application 280. When the host application 280 initially launches, the observer 285 will trigger the required native operating system 275 functionality to run without any additional intervention required from the host application 285. When the callbacks are triggered, all data collected is captured without needing any user input, so no user notifications are generated, and the user interface (UI) of the application 280 does not need to be modified to function as designed. In an aspect, when the mobile device 105 goes into range, or out of range, of one of the external sensors, the callbacks are triggered. In addition, callbacks can be triggered based upon the settings of the observer 285. For example, the observer 285 can also check periodically (e.g., every 3-15 minutes) if the mobile device 150 has moved from its previous known position. When the processes are instantiated via the observer 285 on the host application 280, the observers 285, based upon parameters assigned by the SDK, places the required triggers in place so the callbacks can be initiated.

The host application 280 can be any type of application, including, but not limited to, a game, a rich media application, a utility application, or a merchant application. In an aspect, the observer 285 runs as part of the application 280, although the functionality of the observer 285 is hidden from the UI of the application 280. In an aspect, the observer 285 is in a non-transitory format. The observer 285 may be an executable portion of instructions as part of the host application 280. The observer 285 may also exist separately as a standalone application that interacts with the host application 280 through interfaces. In an aspect, the application 280 is configured to require permission from the user before allowing the host application 280, and the observer 285, to have access to location services. In such aspects, the user only needs to opt in to the use of location or location services by the host application 280 if the host application 280 would otherwise be denied access from these services.

When the host application 280 is launched, the observer 285 begins to operate. The observer 285 operates independently or semi-independently within the host application 280. That is, the observer 285 is added to an existing host application 280 without the host application 280 deviating from the experience as if the observer 285 were not present. In an aspect, this is accomplished by the programming provided by the SDK when creating the observer 285, establishing a background service running on the device 105, or through monitoring interactions with external sensors. No input is required from the host application 280, nor from the user (after the initial authorizations are granted) so the observer 285 can operate independent of any user interaction.

In an aspect, if multiple applications 280 containing observers 285 are running on a device 105, each observer 285 can collect and transmit data independent of any other observer 285. Each time a logging event occurs, the observer 285 will log the location of the device 105, the current timestamp, and a device identifier. Examples of logging events include, but are not limited to, the mobile device 105 entering into range of an external sensor such as a Bluetooth beacon, the mobile device 105 leaving the signal range of the Bluetooth beacon, and the observer 285 determining that the device 105 is in a new location by seeing if the mobile device has moved far enough to log the a location by comparing the current device location vs. the previous location. Ideally, the device identifier is a unique identifier. Residing as part of host application 280, the observer 285 will operate as long as the host application 280 is installed on the mobile device 105, regardless of whether the host application 280 is active.

Triggering or initiating the observer 285 to check for the current location of the device 105 can occur in several ways. For example, the activation of the observer 285 can be controlled by a timer, ordering the observer 285 to update the logs periodically. The activation can be initiated either by a service generated by the observer 285, or the observer 285 subscribing to another existing service available in the operating system. In another aspect, the observer 285 can set system callbacks such that the current location data of the observer 285 updates based on a changed condition reported, including the notification of a changed connection by the operating system 275, directly or via other sensors, of the mobile device 105. In such aspects, for example, the current location data of the observer 285 can be updated when a new connection is established, when a connection is lost, or when the mobile device 105 has moved approximately some predefined distance. In an aspect, the callback can be programmed only to notify the observer 285 after the predefined movement has occurred. However, in other aspects, the observer 285 can be modified and the distance can be verified after receiving the callback. The method for triggering a location data update by the observer 285 can be set via configuration settings or parameters. In an aspect, the parameters can include, but are not limited to, a minimum distance, including vertical (e.g., changing floors in a building) and horizontal movement, between the previous and current location of the mobile device 105, which is adjustable as well. The observer 285 can also be set to log location data points when lateral (i.e., horizontal) movements of the mobile device 105 meet or exceed the minimum distance parameter, and refrain from updating the log location data points when the lateral movements are determined to be too short. In another aspect, addition, the observer 285 is configured to have multiple triggering events to initiate the collection and updating of location of the mobile device 105. For example, the timer as well as the callbacks discussed above can be implemented in concert (i.e., working together) by the observer 285.

In addition, the mobile device 105 communicating with beacons 110 and transmitters 120 can trigger the observer 285. For example, the operating system 275 may track the beacons 110 encountered by the mobile device 105. In such embodiments, the operating system 275 of the mobile device 105 will scan for certain UUIDs, and when a monitored (i.e., one of the certain) UUID is found, the operating system 275 will alert the host application 280, which can then cause the observer 285 to take action. Some beacons 110 shift/change the identifiers every few seconds/minutes to keep unauthorized apps from knowing the actual unique identifiers. When such beacons 110 hide their UUIDs, the mobile device 105 is required to call their APIs to identify a beacon. For example, the observer 285 can implement APIs from Estimote, Gimbal, Onyx Beacons, StickNFind, and other APIs to obtain beacon IDs from beacons from these vendors. The vendor APIs collect additional information specific to that vendor's beacon that are not retrievable from a more universal communication standard, such as iBeacon. For example, the beacon may transmit its location. Many beacons implement the Apple defined iBeacon standard. Other standards, such as the Radius Networks Alt Beacon and the Google Eddystone standards that included additional features (e.g., the physical website where the beacon sends a URI to the mobile device/phone) may be implemented by the beacon and provide additional information which can be used to determine the user location. In addition, while the observer 285 is operating, it will continuously search for transmitters, including, but not limited to, Bluetooth, Wi-Fi, cell towers, Visual Light communication (VLC)/Li-Fi, and Near Field Communication (NFC) transmitters.

Wi-Fi access points will transmit their medium access control (MAC) address. The application 280, through the operating system 275, has access to the available Wi-Fi networks. This MAC address information is logged (e.g., by the observer 285) in a period manner as before. For mobile devices 105 that change their MAC address, the operating system 275 can learn that this change in MAC address occurs from seeing the changes in a particular location over time in the logged data. Likewise, the observer 285 can capture the Wi-Fi access point's SSID and use this identifier in a similar manner. Once the embedded observer 285 is triggered and has collected the relevant data, the observer 285 will store this data within the host application 280. Then the stored data can be synchronized with the data storage of the system backend.

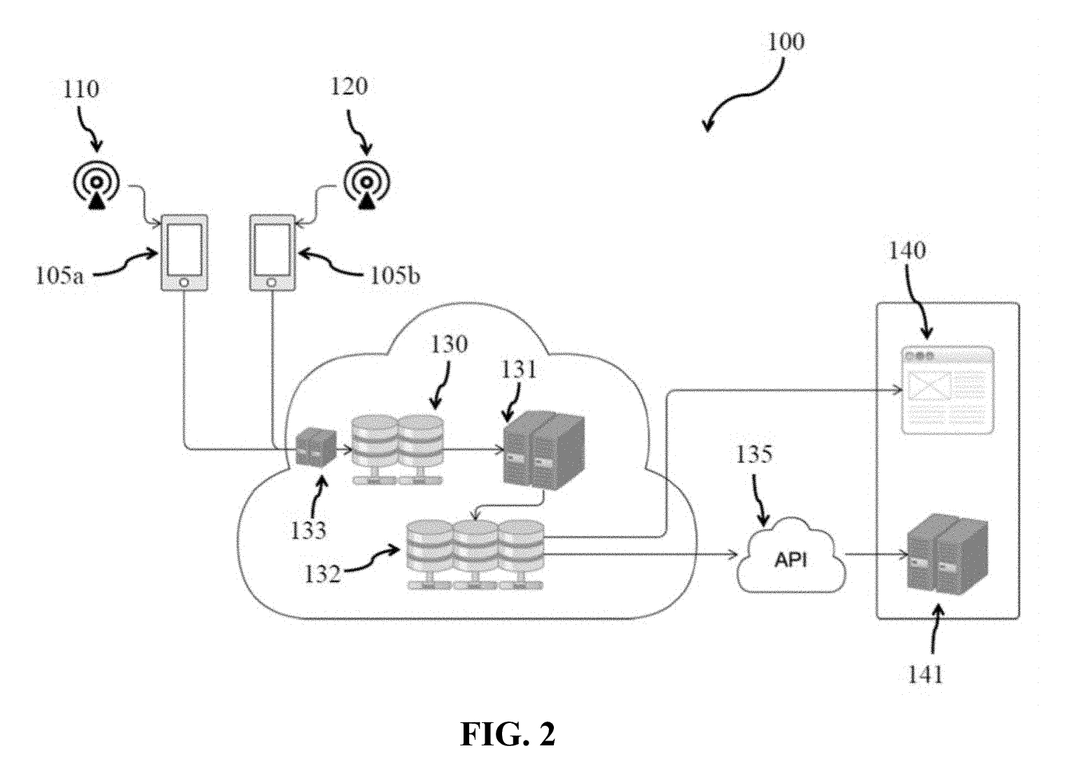

FIG. 2 is a schematic diagram of a tracking system 100 with server components, according to an embodiment of the present invention. A first mobile device 105a can connect to a beacon 110. The beacon 110 can be a Bluetooth beacon or any other type as discussed above. The embedded observer 285 (not shown in FIG. 2) will collect the mobile device identifier and the identifiers relating to the beacon 110. Likewise, a second mobile device 105b may connect separately to a communication network 120. The communication network 120 may be a Wi-Fi network or a cellular network. The embedded observer 285 within the application 280 (neither shown in FIG. 2) will log the mobile device identifier and the identifiers relating to the communication network 120. The mobile device 105 may also receive GPS signal from a set of GPS satellites (not shown) and directly determine its position.

The data logged by the observer 285 on the mobile device 105 is synchronized with a raw data points data storage 130, which stores the logged data. The data can be stored in a database format. In an aspect, the built-in communication functionality in the observer 285 transmit the data. In an embodiment, the observer 285 uses an API call to transmit the data. This data can be retrieved by a mobile tracking system server 131, which can periodically or on demand retrieve the data from the raw data points data storage 130 to perform processing. In an embodiment, the data goes first to an API server 133 that checks the validity of the data. Once the data is validated, the data point is sent to the raw data points data storage 130. The mobile tracking system server 131 provides functionality for processing the data collected by the embedded observers 285 within the applications 280 of the devices 105 and produces insights from the raw data.

The insights produced by the mobile tracking system server 131 include determining which wireless transmitter and/or beacon, such as a Wi-Fi base station, a Bluetooth beacon 110, a cellular base station, or an NFC station, with corresponding identifying data, is closest to the mobile device 105 at the times the data was logged, and extrapolated for times in-between logging events. Contextual data (e.g., data already stored on the server), such as information on where particular transmitters (e.g., 110 and 120) are located, can be correlated with the logged data to enhance the data set. For example, retrieval of the location of the transmitters is done by utilizing the transmitter identifiers. Logged data from the mobile device 105 can be associated with this known transmitter location information by the same or similar transmitter identifiers. Thus, the location of the mobile device 105 can be determined. In addition, the system 100 can record the position provided by the mobile device 105 through its GPS radio or other provided location and report an identifier from an unknown beacon or radio.

The mobile tracking system server 131 may further process the data to provide summarized data. While mobile devices 105 may be accurately tracked in inches using the described approach of associating contextual data with information about the transmitters the mobile device 105 encounters, it may be useful to consolidate the data. For example, the mobile tracking system server 131 can consolidate and summarize the data to show that a user of the mobile device 105 entered a store from a particular entrance, spent various amounts of time in the different sections of the store, and then left through a particular exit. In an embodiment, the entrance, exit, or other points of interest of a location are known by using the transmitter definition contained in the database of the tracking system server 131. This summarized data can be used to measure customer engagement or may be used to measure and determine the effectiveness of a vendor's mobile application 280 beyond just the number of downloads. That is, the vendor of the mobile application 280 found on mobile device 105 is able to understand more about the movements of their customer (i.e., the user of the mobile device 105 that includes the mobile application 280), including if and when the user is using vendor's mobile application 280. The observer 285 provides the ability to set the “eventType” when sending a data point, so the host application 280 developer can choose to send a data point when the host application 280 is opened, closed, or whenever the user of the mobile device 105 interacts with a feature within the host application 280. In an embodiment, the host application 280 employs tracking to provide insights into how users are interacting with physical locations. Similarly, measuring in-store activities may show how successful the application is at driving specific key outcomes.

In an aspect, the mobile tracking system server 131 is a cloud-based device. The data collected by the observer 285 ingests data into a cloud-based backend via mobile APIs, which is to query outside services that add contextual data to the individual data points. For example, contextual data can be brought in from OpenStreetMap, Geonames, Factual, Gravy, Foursquare, Google, other social media websites, and other publically available websites. The social media websites can provide information about activities of the user of the mobile device 105 that occur on the social media websites. For example, the additional contextual data can include the “like” selections on Facebook made by the user of the mobile device 105, as well as likes generated by friends of the user of the mobile device 105. Such contextual data can be pulled from public or private APIs and publically available websites. Other contextual data includes the country, state/province, county, zip/postal code, current time zone, nearest physical street address, business name, etc. The mobile tracking system server 131 then compares one location data point to the previous location data point to determine the dwell time, or the amount of time the mobile device 105 spent at the previous data point. From this dwell time, the mobile tracking system server 131 can infer behavior patterns and intent of the user of the mobile device 105. Using this intent compared with the local time when the data point was captured, the mobile tracking system server 131 is able to determine if the previous data point is the mobile device's user's home location, work location, a location where the user is hanging out, or if the user is commuting or travelling as the point was captured. Batch or real time processing can be done as each new data point is captured or logged. Furthermore, machine learning can be applied by the mobile tracking system server 131 to produce further information about the user of the mobile device 105.

Machine learning (ML) can be used to analyze the business Points of Interest (POI) and based on the types of businesses they visit, and the frequency of these visits. Based upon this information, the system can identify similar behavior, which allows the system to group individuals with similar behavior together. We also use ML to observe the amount of time users spend in certain areas and based on that determine where the user lives, works, normally eats lunch during the week, and their commute patterns. ML can be used to determine if the current location of the user is within their normal pattern, or if they are outside of their normal pattern.

In an aspect, the observer 285 can perform active power management in concert with the mobile tracking system server 131. For example, as the mobile device 105 moves from one location to the next, the observer 285 communicates with the mobile tracking system server 131 to determine the transmitters (i.e., identifying the local transmitters, such as a Bluetooth transmitters) that are within a particular radius from the mobile device 105 location. In general, the radius is set within the SDK, and the user of the mobile device 105 is not able to change the radius. This radius is set this based on the minimum distance that the mobile device 105 will move before the observer 285 will log another data point. The observer 285 can monitor for the sensors within this radius and ignore any sensor that is outside of this radius. When the observer 285 determines that the device 105 has moved, the sensors or logging frequency can be reset so that the observer 285 will react. Thus, battery consumption while the host application 280 is used can be limited. Once a qualifying location confirmation is logged, the wireless radio (e.g., the Wi-Fi radio 220 or Bluetooth radio 221) of the mobile device 105 that detected the sensor is immediately deactivated and only activated again when software logic of the observer 285 determines that a specific wireless radio should be activated again. For example, when using GPS to determine the device location, the observer 285 will check as the GPS sensor/radio 222 reports the latest location. Once the location accuracy is reported from the GPS sensor 222 as within 30 m, the observer 285 tells the operating system 275 to turn off the GPS scanning. Turning off the GPS radio 222 saves power by only allowing the GPS scanning to take place until the observer 285 has an accurate location fix. In an aspect, if the accuracy does not go below 30 m, then the observer 285 performs this scanning for a maximum number of iterations (e.g., 10) and keeps the value with the best horizontal accuracy value. The observer 285, after determining when the required information is captured, can command the operating system 275 to turn off the specific internal device radios no longer required via specific operating system methods to control the radios. The mobile device's 105 wireless radios will turn on again either when the device operating system 275 determines it should be reactivated, or when one of the observer's 285 timers is triggered again so as to look for other nearby sensors.

The observer 285 can include functionality to exclude personally identifying information. While the host application 280 can have access to or collect such information, this data can be specifically filtered out by the interface to the observer 285 or by not sending the data to the raw data points data storage 130. The data fields can be defined per host application 280 to know which fields include personal identified information (PII) to exclude those values. In an aspect, the system is configured to operate using a base list of non-PII fields and only ingest those values from the host applications 280.

As discussed above, the observers 285 of each mobile application 280 on a mobile device 105 can run independently of each other. In such cases, the various observers 285 can be active (e.g., mobile application 280 is in use, calling upon the observer 285), previously active (e.g., a mobile application 280 was running earlier, but has been shut down), or not active at all (e.g., a mobile application 280 has not be opened). In each case, the associated observers 285 can have various amounts of data collected independently of one another. In such aspects, the system 100 is able to combine data from any of the observers 285 embedded in the applications 280 running on the user's mobile device 105. More specifically, the mobile tracking system server 131 can aggregate the location data for a particular mobile device 105 across the several applications 280 on the mobile device 105 that include the embedded observer(s) 285. Thus, the system 100 is still able to generate location information and insights even if one of the many applications 280 with the embedded observer 285 is not running. Each observer 285 works independently without knowledge of the other host applications 280. The host application 280 will relaunch as required to capture data points.

Furthermore, the mobile tracking system server 131 provides access to the insights through a mobile tracking API 135. The customer's own analytics software, residing on the customer server 141, can make calls using the mobile tracking API 135 to retrieve the insight information to integrate with their own proprietary data via a customer server 141. By mixing the data provided by the mobile tracking API 135 with other data, a richer understanding of the user of the mobile device 105 can be made, which in turn can provide better marketing, loyalty, service, delivery, and/or business decisions. In an aspect, an online analytics portal 140 allows additional interactions with the system 100.

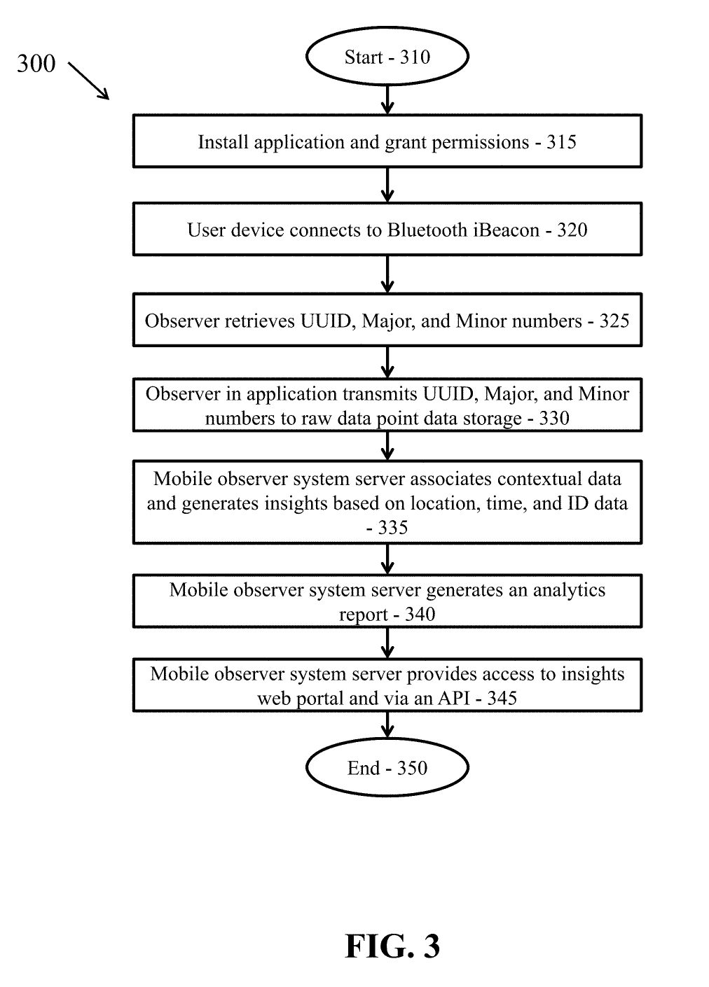

FIG. 3 is a flow diagram of the data capture and analysis process (300) for Bluetooth beacons by the system 100, according to an embodiment of the present invention. At step 310, the Bluetooth beacon data collection process starts. The user of the mobile device 105 installs the host application 280 that contains the observer 285 in step 315. The application 280 can be installed from a direct download, from removable media, or from an application store, such as the Apple App Store. Upon downloading, the user can also grant permissions to the application 280. The permissions can include, but are not limited to, access to location services, access to location when the application is running in the foreground, or whether running in the foreground or background (aka—always). After installation and assigning permissions, the user's mobile device 105 connects to a Bluetooth iBeacon 110, or any other external sensor, (step 320). From this connection, the mobile device 105 gives access to information about the iBeacon to the host application 280, and therefore the observer 285, through the operating system 275 of the mobile device 105. The observer 285 then retrieves the UUID, Major, and Minor numbers from the Bluetooth connection information (step 325). The UUID, Major, and Minor numbers are then transmitted to the raw data points data storage 130 (step 330). The mobile tracking system server 131 then associates contextual data to generate a location and generates insights based on the location, time, and mobile device ID data (step 335). In an aspect, the insights can then be assembled into an analytics report, which includes information on the users that will most likely be within a given radius of a certain location (latitude/longitude) (step 340).

Once the report is generated, the insights, via the mobile observer system, can provide insights to businesses via a web portal and/or via an API (step 345). This information is a way for the business to know who will be at a given location in the future so the business can adjust business decisions, such as sending relevant marketing information/messaging to the mobile devices 105 of the users. The mobile device ID can be used to target the given mobile device 105 with banner ads, social media ads, mobile web ads, and/or push notifications. In an aspect, the reports can include the name of the report, location, days of week, and the time of day of monitoring. In addition, the report can includes the mode the mobile device 105 will be in, such as Home, Work, Hangout, or Commute. This analytics report is based on the location, time, and mobile device ID data, an analytics report. After supplying the information, the process can end (step 350). The API also exposes particular information. For example, the API can be used to retrieve the most up to date audience list with the same information that is included in the report (AdID, mode of the device at the given days/times, etc.). This information is retrieved by submitting a specific audience list ID through the API, then retrieving the definition of all configured audience lists.

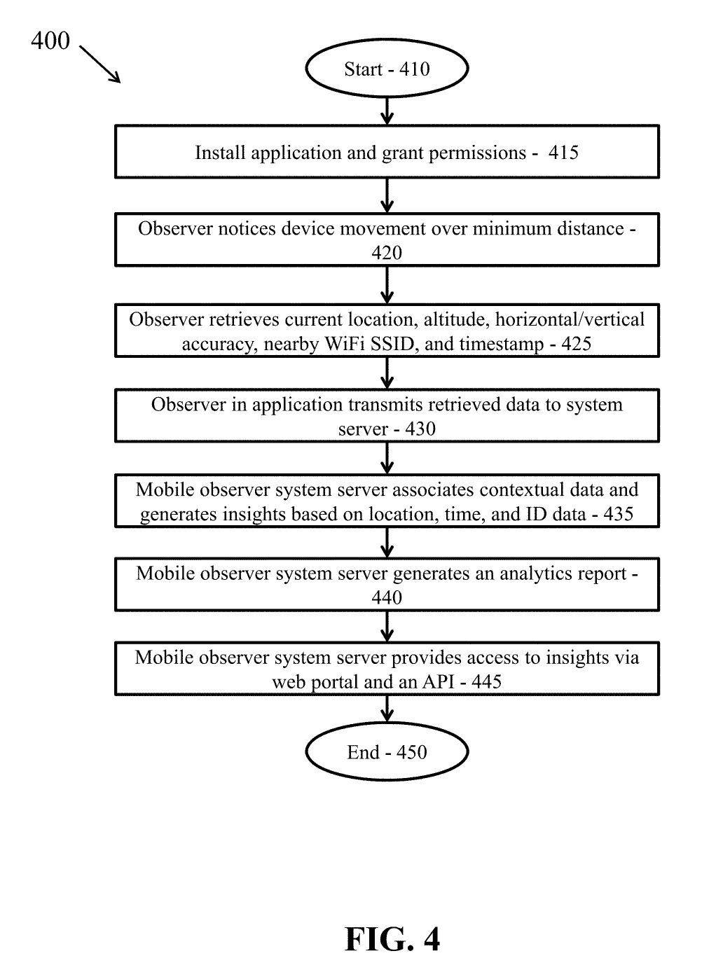

FIG. 4 illustrates how the movement and location of a mobile device 105 is tracked via the mobile observer system operation 400, according to an embodiment of the present invention. First, the mobile observer system operation is initiated (step 410), which can be the offering of the host application 410. The host application 280, with the observer 285, is installed on the mobile device 105 and the user grants the required permissions to the host application 280 (step 415). The observer 285 detects device movement over a minimum distance (step 420). Upon determining the requisite movement, the observer 285 retrieves current location, altitude, horizontal/vertical accuracy, nearby Wi-Fi SSID, and time stamp data (step 425). Upon completion of collection, the observer 285 transmits retrieved data to system server 131 (step 430). The mobile tracking system server 131 then can associate contextual data and generate insights based on location, time, and ID data received (step 435), which can then generate an analytics report (step 440). Generating the analytics report may be optional in certain embodiments. In either case, the mobile observer system server 131 can then provide access to insights via web portal and an API (step 445) before the process ends (step 450).

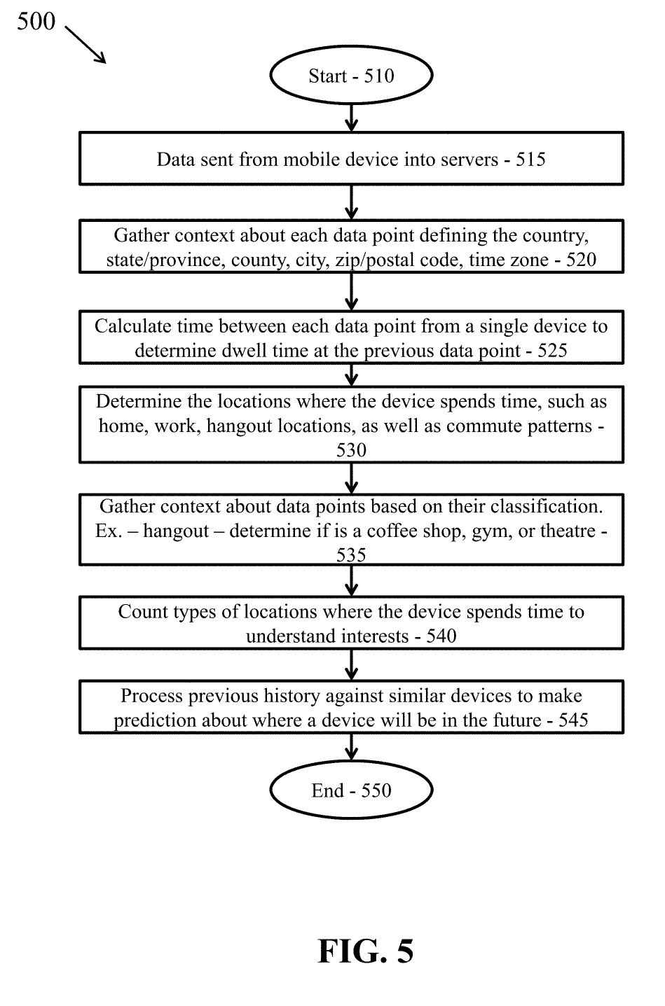

FIG. 5 illustrates a method (500) of processing the collected data into insights that are delivered via a portal by APIs to customers according to an aspect of the present invention. Once the mobile devices 105 have collected some data (step 510), the data is sent to the mobile tracking system server 131 for processing (step 515). The data can be sent directly to an API server 133 or to the data storage 130 before being passed along to the mobile tracking system server 131. Once received, the mobile tracking system server 131 gathers/retrieves context about each data point (step 520). The data point can include all spatial and location information, including, but not limited to, the county, state/province, county, city, zip/postal code, time zone, and time stamp. Other information collected can include the location fix horizontal and vertical accuracy, the Wi-Fi SSID if connected to Wi-Fi, the wireless carrier, the device model, the device manufacturer, and the operating system and version. After the information is gathered, the mobile tracking system server 131 calculates the time between each data point from a single device to determine the dwell time at the previous data point (step 525). To perform this step, the mobile tracking system server 131 pulls past information about the mobile device 105 that it has already stored. After determining the dwell time, the mobile tracking system server 131 determines the locations where the mobile device 105 “dwells”, and identifies them (step 530). For example, the mobile tracking system server 131 determines if the device 105 is found at a user's home, work, a hangout/frequented place (e.g., gym, coffee shop, theatre), or a commute pattern by looking at the dwell time of the data point, as well as if the data point is near to the location flagged as home or work for the device.

Once the location is classified, the mobile tracking system server 131 is configured to gather context about the data points based upon their classification (step 535). For example, if the place has been identified as a hangout place, the mobile tracking system server 131 determines if the type of place it is (i.e., is it a coffee shop, a gym, a theater). For hangout places, the system 100 matches the location to outside data vendors to determine the businesses nearby the user. The system determines the most likely business the device visited by comparing the types of businesses to the dwell time, time of day, and previous behavior of the device. Once the place has been identified, the mobile tracking system server 131 is configured to determine the interests of the user by counting/analyzing the number and types of places frequents with the device (step 540). After interests are found, the mobile tracking system server 131 can then compare the user device 105, and the data/history associated with it, to devices that have similar histories in order to make predictions as to where the device will be in the future (step 545). Once predictions are generated, the mobile tracking system server 131 completes its analysis (step 550). The mobile tracking system server 131 can then provide the information to selected users for advertisement purposes or the like.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. To the extent necessary to understand or complete the disclosure of the present invention, all publications, patents, and patent applications mentioned herein are expressly incorporated by reference therein to the same extent as though each were individually so incorporated.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

We claim:

1. A system for providing location information of a mobile device, the system comprising:
a. a mobile device comprising:
i. at least one radio configure to communicate with another corresponding radio of another device; and
ii. at least one host application, wherein the at least one host application comprises an observer embedded in the host application and configured to capture data about the mobile device;
b. a mobile tracking system server configured to:
i. receive the mobile device data wirelessly from the mobile device; and
ii. correlate the mobile device data with contextual data stored on the mobile tracking system server.

2. The system of claim 1, wherein the mobile device data comprises a radio identifier, a timestamp, and device identifier of the mobile device, wherein the mobile tracking system server is further configured store the radio identifier with stored location data corresponding to the radio identifier to generate location data and associate the location data with the device identifier.

3. The system of claim 2, wherein the mobile device data further comprises a universal unique identifier of the radio of the other device.

4. The system of claim 1, wherein the observer is configured to operate without intervention on the host application.

5. The system of claim 4, wherein the observer is activated to collect the mobile device data by triggering a callback.

6. The system of claim 5, wherein the trigger comprises the host application being activated.

7. The system of claim 5, wherein the trigger occurs via a timer.

8. The system of claim 5, wherein the trigger comprises a service.

9. The system of claim 5, wherein the trigger comprises a changed condition of the mobile phone.

10. The system of claim of 9, wherein the changed condition is notified by a sensor on the mobile device.

11. The system of claim 5, wherein the trigger is movement of the mobile device of a predefined distance.

12. The system of claim 11, wherein the predefined distance includes vertical and horizontal distances.

13. The system of claim 5, wherein the trigger is communicating with radios of other devices.

14. The system of claim 1, wherein the observer is configured to remove personal identified data before transfer.

15. The system of claim 1, wherein the at least one host application comprises a plurality of host applications comprising an observer, wherein the plurality of observers operate independently of one another to capture mobile device data.

16. The system of claim 1, further comprising a validating server and a raw data storage, wherein the data is validated by the validating server before being stored in the raw data storage, wherein the mobile tracking system server obtains the data from the raw data storage.

17. A system for determining the location of a mobile device, the system comprising:
a. a storage database containing contextual data;
b. a mobile device having a device identifier and comprising:
i. a first wireless radio, and
ii. a non-transitory storage medium comprising executable instructions for a host application, wherein the host application comprises executable instructions for an observer that receives a transmitter identifier from the first wireless radio, stores the transmitter identifier, and sends the transmitter identifier and the device identifier to the storage database to be stored; and
c. an analytics server configured to retrieve the transmitter identifier and device identifier from the storage database, retrieve contextual data from the storage database, perform an association on the transmitter identifier and contextual data to produce a location, associate the location with the device identifier, and transmit the device identifier and the location over a computer network.
